(19) United States
(12) Patent Application Publication
(10) Pub. No.: US 2019/0055942 A1
(43) Pub. Date: Feb. 21, 2019

(54) PUMPING ASSEMBLY TO FEED FUEL, PREFERABLY DIESEL FUEL, TO AN INTERNAL COMBUSTION ENGINE

(71) Applicant: Robert Bosch GmbH, Stuttgart (DE)

(72) Inventor: Riccardo Scamarcio, Massafra (TA) (IT)

(21) Appl. No.: 16/080,091

(22) PCT Filed: Jan. 5, 2017
(86) PCT No.: PCT/EP2017/050180

§ 371 Date: Aug. 27, 2018

(30) Foreign Application Priority Data
Feb. 25, 2016 (IT) 102016000019750

(51) Int. Cl. F04C 15/00; F04C 2/10; F02M 59/12

(52) U.S. Cl. CPC F04C 15/0015; F02M 59/12; F04C 2/10

(57) ABSTRACT

A pumping assembly to feed fuel, preferably diesel fuel, to an internal combustion engine is provided with an electric gear pump (7) having two gears (33, 37) mounted one inside the other, and of which one is an annular rotor (33) mounted rotatably on the inside of a stator (29) through the interposition of a support bearing (42), which is delimited by a substantially cylindrical side wall (43) having at least one strip (47) of elastically deformable material which is substantially parallel to a rotation axis (30) of said rotor (33).

The present invention relates to a pumping assembly to feed fuel, preferably diesel fuel, to an internal combustion engine.

In particular, the present invention relates to a pumping assembly of the type comprising a high-pressure pump, for example a piston pump, designed to feed the fuel to an internal combustion engine; and a pre-feed pump designed to feed the fuel from a storage tank to the high-pressure pump.

The pumping assembly is further provided with a hydraulic circuit comprising a first branch for connecting together the storage tank and the pre-feed pump, a second branch for connecting together the pre-feed pump and the high-pressure pump, and a third branch for connecting together the high-pressure pump and the internal combustion engine.

The pre-feed pump is an electric gear pump provided with a containing casing comprising a cup-shaped pump body and a closing lid to close said pump body.

The containing casing houses internally a synchronous, brushless, permanent-magnet, electric motor, comprising an annular-shaped stator, which has a plurality of copper windings distributed uniformly about a longitudinal axis thereof, and is provided with an electrical connector to feed said windings.

The electric motor further comprises an annular-shaped rotor, which is engaged in a rotary manner in the stator through the interposition of a support bearing, and is mounted so as to rotate about a rotation axis coinciding with the longitudinal axis of said stator.

The rotor has inner teeth and defines an outer gear of the gear pump, which further comprises an inner gear housed inside the rotor.

The inner gear is mounted so as to rotate about a rotation axis which is eccentric with respect to the rotation axis of the rotor, and has outer teeth meshing with the inner teeth of said rotor.

The two sets of teeth are formed so as to define a plurality of variable-volume chambers, which are distributed about the rotation axis of the rotor, and are coupled together in a fluid-tight manner.

Following the rotation of the outer gear and of the inner gear about the respective rotation axes, each variable-volume chamber is connected hydraulically in succession firstly to a fuel inlet into the gear pump and then to a fuel outlet from said gear pump.

The rotor further comprises a plurality of pockets, which are configured to each house inside them a respective permanent magnet and are distributed about the rotation axis of said rotor.

The support bearing of the rotor has a cylindrical shape, is coaxial to the longitudinal axis of the stator and is made of a plastic material.

The support bearing is further coupled to the pump body and to the closing lid in a fluid-tight manner by means of respective annular gaskets, which are mounted coaxially to the longitudinal axis of the stator and ensure correct isolation of the stator from the fuel present in the variable-volume chambers under the operative pressure and temperature conditions to which the gear pump is subjected.

Since the support bearing is blocked by interference inside the stator, the known pumping assemblies of the type described above have a number of disadvantages, mainly arising from the fact that the processes for assembling the support bearing on the stator involve radial deformation of said support bearing.

The radial deformation of the support bearing varies with the working temperature of the gear pump and jeopardizes the functions of the support bearing, that is to say the functions of centering the rotor in the stator and of isolating the stator from the fuel present in the variable-volume chambers.

It is an object of the present invention to provide a pumping assembly to feed fuel, preferably diesel fuel, to an internal combustion engine, which does not have the above-described disadvantages and is simple and inexpensive to produce.

According to the present invention, a pumping assembly to feed fuel, preferably diesel fuel, to an internal combustion engine is provided as claimed in the accompanying claims.

The present invention will now be described with reference to the accompanying drawings, which illustrate a non-limiting exemplary embodiment thereof, in which:

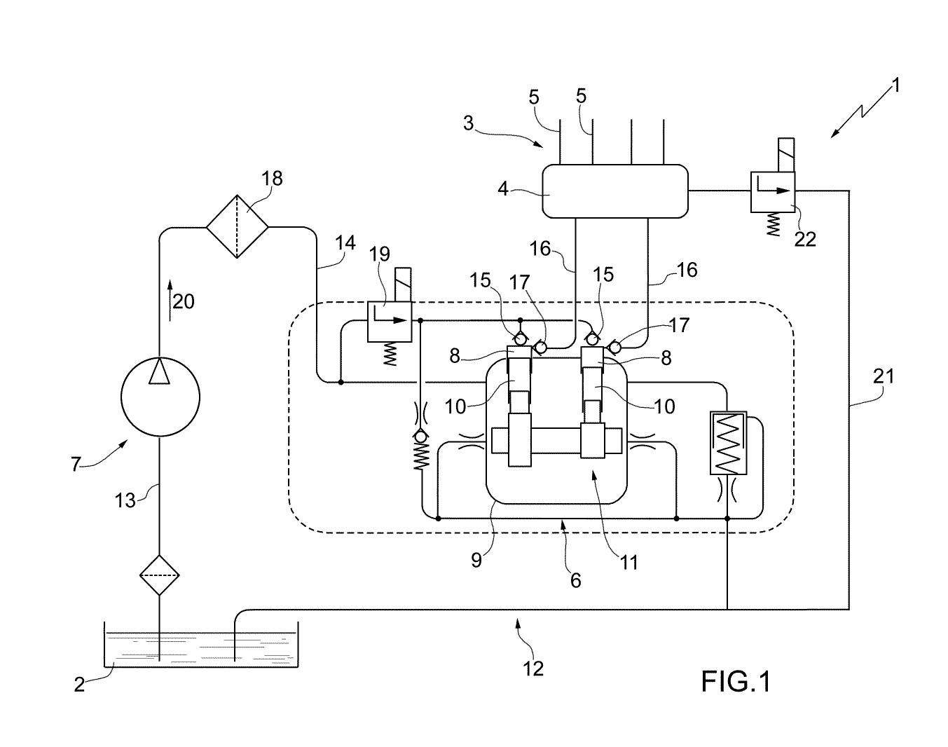

FIG. 1 is a hydraulic diagram of a preferred embodiment of the pumping assembly of the present invention;

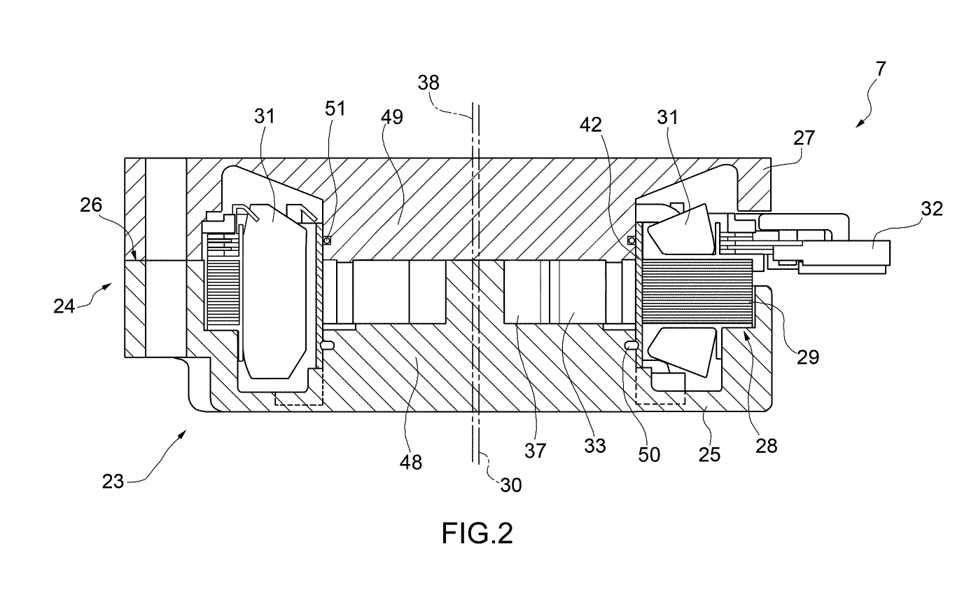

FIG. 2 is a schematic longitudinal section, with parts taken away for clarity, of a detail of the pumping assembly shown in FIG. 1;

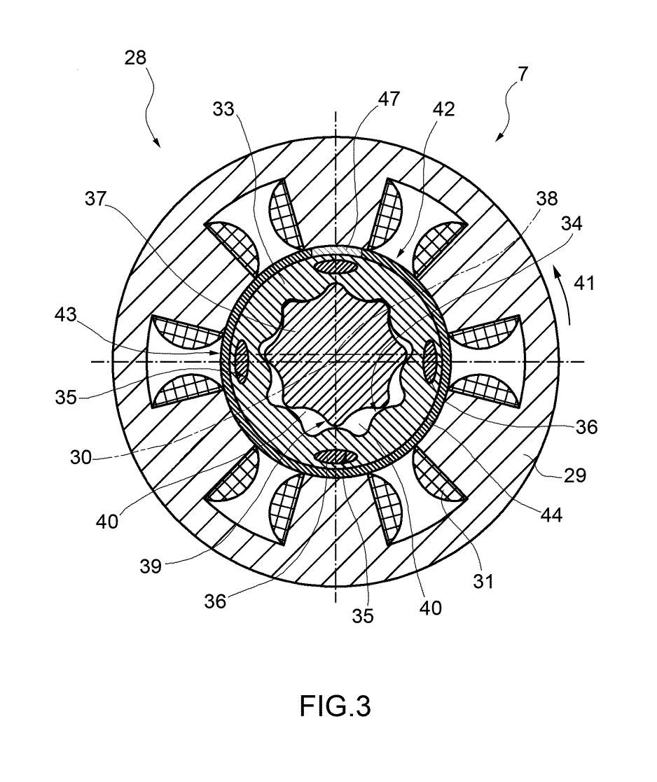

FIG. 3 is a schematic cross section, with parts taken away for clarity, of a detail of FIG. 2; and

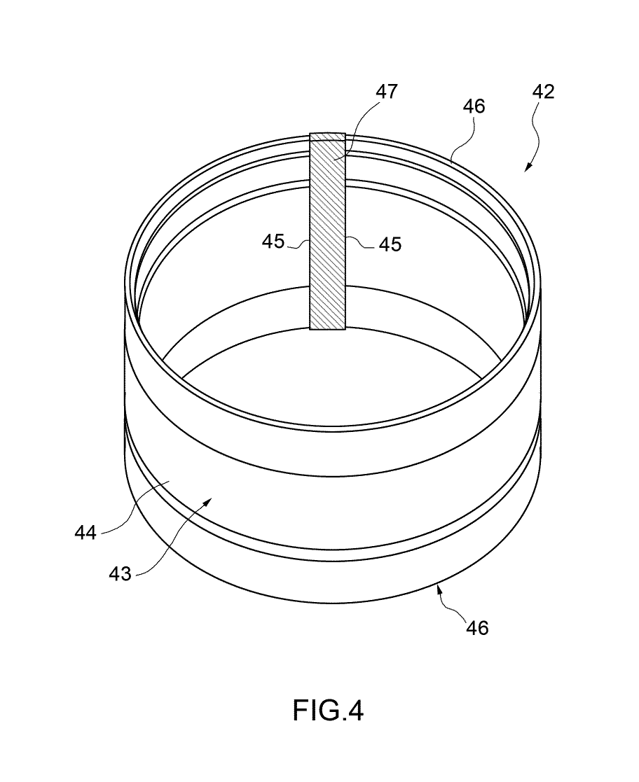

FIG. 4 is a schematic perspective view of a detail of FIGS. 2 and 3.

With reference to FIG. 1, 1 denotes in its entirety a pumping assembly to feed fuel, preferably diesel fuel, from a storage tank 2 to an internal combustion engine 3, in the case in question a diesel combustion engine comprising a fuel distribution manifold 4, commonly referred to by the term “common rail”, and a plurality of injectors 5 connected to the manifold 4 and designed to atomize the fuel inside associated combustion chambers (not shown) of said engine 3.

The pumping assembly 1 comprises a high-pressure pump 6, in the case in question a piston pump, designed to feed the fuel to the engine 3, and a low-pressure or pre-feed pump 7 designed to feed the fuel from the tank 2 to the pump 6.

The pump 6 comprises a plurality of cylinders 8 (in the case in question two cylinders 8) which are formed in a pump body 9 and are each slidably engaged by a respective piston 10.

The pistons 10 are displaced along the associated cylinders 8 by an actuating device 11 of the known type housed inside the pump body 9 with an alternating rectilinear movement comprising an outward stroke for drawing the fuel into the associated cylinders 8 and a return stroke for compressing the fuel contained in said associated cylinders 8.

The pumping assembly 1 further comprises a hydraulic circuit 12 to feed the fuel comprising, in turn, a first branch 13 for connecting together the tank 2 and the pump 7; a second branch 14, which connects together the pumps 6 and 7, extends through the pump body 9 in order to lubricate the actuating device 11 and is connected to each cylinder 8 by means of an associated intake valve 15; and a third branch 16 which extends between the pump 6 and the manifold 4 and is connected to each cylinder 8 by means of an associated delivery valve 17.

The branch 14 is provided with a device 18 for filtering the fuel fed to the pump 6 and with a metering electrovalve 19 which is mounted upstream of the valves 15 in a direction 20 of feeding of the fuel along the branches 13, 14 and 16 and is movable between a closed position and an open position for selectively controlling the instantaneous fuel flow fed to the pump 6 depending on the values of a plurality of operating parameters of the engine 3.

The circuit 12 further comprises a fourth branch 21 which extends between the manifold 4 and the tank 2 and is provided with a metering electrovalve 22 which cooperates with the electrovalve 19 in order to selectively control the fuel flow fed to the injectors 5 and allows the amount of fuel exceeding that required by the injectors 5 to be discharged into the tank 2.

As is illustrated in FIGS. 2 and 3, the pump 7 is an electric gear pump provided with a containing casing 23 comprising a pump body 24, which has a cup shape, is delimited by a bottom wall 25 and by a free end face 26 which are opposite one another and parallel to one another, and is closed by a lid 27 arranged in contact with said face 26.

The casing 23 houses internally a synchronous, brushless, permanent-magnet, electric motor 28, comprising an annular-shaped stator 29, which has a longitudinal axis 30 perpendicular to the wall 25 and to the face 26, and is provided with a plurality of copper windings 31, which are distributed uniformly about the axis 30 and are fed electrically by means of an electrical connector 32.

The stator 29 is engaged in a rotary manner by an annular-shaped rotor 33, which is mounted coaxially with the axis 30, has inner teeth 34, and defines an outer gear of the pump 7.

The rotor 33 further comprises a plurality of pockets 35, which are distributed uniformly about the axis 30 and are configured to each house inside them a respective permanent magnet 36.

The pump 7 further comprises an inner gear 37, which is housed inside the rotor 33, is mounted so as to rotate about a rotation axis 38 parallel to, and separate from, said axis 30, and has outer teeth 39 meshing with the inner teeth 34 of the rotor 33.

The two sets of teeth 34, 39 are formed so as to define a plurality of variable-volume chambers 40, which are distributed about the axis 30 and are coupled together in a fluid-tight manner.

Following the rotation of the rotor 33 and of the gear 37 about the respective axes 30, 38, each chamber 40 is connected hydraulically in succession firstly to a fuel inlet (not shown) into the pump 7 and then to a fuel outlet (not shown) from said pump 7.

In connection with the above comments, it should be pointed out that the volume of the chambers 40 associated with the inlet (not shown) increases in a direction 41 of rotation of the rotor 33 about the axis 30 and of the gear 37 about the axis 38, and that the volume of the chambers 40 associated with the outlet (not shown) diminishes in the direction 41 so as to compress the fuel contained therein.

The rotor 33 is coupled to the stator 29 in a rotary manner through the interposition of a cylindrical support bearing 42.

The bearing 42 is delimited by a substantially cylindrical side wall 43, which is coaxial with the axis 30 and comprises a cylindrical ring 44 made of a plastic material, which extends about the axis 30 according to an angle smaller than 360°, and has two free ends 45, which are separate from one another and substantially parallel to said axis 30.

The wall 43 is delimited axially by two end faces 46 which are substantially parallel to one another and perpendicular to the axis 30, and further comprises a strip 47 of elastically deformable material (in the case in question, rubber), which extends between the faces 46 parallel to the axis 30 and has two side edges connected to the free ends 45.

The bearing 42 is further engaged centrally by a centering block 48 protruding axially from the bottom wall 25 of the pump body 24 and by a centering shank 49 protruding axially from the lid 27.

The bearing 42 is coupled in a fluid-tight manner to the block 48 through the interposition of an annular gasket 50 coaxial with the axis 30 and to the shank 49 through the interposition of an annular gasket 51 coaxial with said axis 30.

The bearing 42 is coupled to the stator 29 by means of a relatively simple and fast operating sequence, comprising a first step, in which the bearing 42 and therefore the strip 47 are compressed tangentially so as to allow the bearing 42 to assume a diameter which is smaller than the diameter of the stator 29; a second step, in which the bearing 42 is inserted axially into the stator 29; and a third step, in which the bearing 42 and therefore the strip 47 are relaxed so as to allow the bearing 42 to assume a diameter which is the same as the diameter of the stator 29, and, therefore, to become blocked axially by friction inside said stator 29.

As a result, the operations for assembling the bearing 42 on the stator 29 do not involve any radial deformation of the bearing 42 and do not compromise the functions of said bearing 42, that is to say the functions of centering the rotor 33 in the stator 29 and of isolating the stator 29 from the fuel present in the variable-volume chambers 40.

1. A pumping assembly to feed fuel to an internal combustion engine (3), the pumping assembly comprising a high-pressure pump (6) to feed fuel to the internal combustion engine (3); and a gear pump (7) to feed fuel to the high-pressure pump (6); the gear pump (7) comprising an electric motor (28) having a stator (29), an annular rotor (33) mounted on an inside of the stator (29) and coupled to the stator (29) in a rotary manner through the interposition of a support bearing (42), and an outer gear (34) on on an inside of the rotor (33); and an inner gear (37), which is mounted on an inside of and is coupled to said outer gear (34); the support bearing (42) being delimited by a substantially cylindrical side wall (43) coaxial to a rotation axis (30) of the rotor (33); wherein the side wall (43) of the support bearing (42) comprises at least one strip (47) of elastically deformable material.

2. A pumping assembly according to claim 1, wherein the strip (47) of elastically deformable material is substantially parallel to the rotation axis (30) of the rotor (33).

3. A pumping assembly according to claim 1, wherein the support bearing (42) is axially delimited by two opposite end faces (46); the strip (47) of elastically deformable material extending between the two end faces (46).

4. A pumping assembly according to claim 1, wherein the strip (47) of elastically deformable material is made of rubber.

5. A pumping assembly according to claim 1, wherein the side wall (43) of the support bearing (42) comprises, furthermore, a cylindrical ring (44) made of a plastic material, which extends around the rotation axis (30) of the rotor (33) according to an angle smaller than 360°, and has two free ends (45), which are separate from one another.

6. A pumping assembly according to claim 5, wherein the strip (47) of elastically deformable material is connected to the two free ends (45) of the cylindrical ring (44).

7. A pumping assembly according to claim 1, wherein the gear pump (7) comprises a containing casing (23) having a cup-shaped pump body (24) and a closing lid (27) to close the pump body (24) itself.

8. A pumping assembly according to claim 7, wherein the pump body (24) is delimited by a bottom wall (25) substantially perpendicular to the rotation axis (30) of the rotor (33), and has a centering block (48), which axially projects from the bottom wall (25), and extends into the support bearing (42).

9. A pumping assembly according to claim 8, wherein the centering block (48) is coupled to the support bearing (42) in a fluid-tight manner through the interposition of a first annular gasket (50).

10. A pumping assembly according to claim 7, wherein the lid (27) has a centering shank (49), which axially projects from the lid (27), and extends into the support bearing (42).

11. A pumping assembly according to claim 10, wherein the centering shank (49) is coupled to the support bearing (42) in a fluid-tight manner through the interposition of a second annular gasket (51).
